(19) United States
(12) Patent Application Publication
(10) Pub. No.: US 2013/0229678 A1
(43) Pub. Date: Sep. 5, 2013

(54) OPERATION PANEL AND INFORMATION PROCESSING DEVICE

(71) Applicants: Tetsuya Ishikawa, Tokyo (JP); Masaki Kakutani, Kanagawa (JP)

(72) Inventors: Tetsuya Ishikawa, Tokyo (JP); Masaki Kakutani, Kanagawa (JP)

(21) Appl. No.: 13/781,640

(22) Filed: Feb. 28, 2013

(30) Foreign Application Priority Data
Mar. 1, 2012 (JP) 2012-45458

(51) Int. Cl. G06K 15/00

(52) U.S. Cl. CPC G06K 15/002
USPC 358/1.14; 358/1.15

(57) ABSTRACT

Disclosed is an operation panel including: an operating unit to receive an operation from a user; a detecting unit to detect whether the operation panel is attached to a predetermined device; a communication unit to be wirelessly communicable with the predetermined device; and a control unit to switch a function of the predetermined device, which can be operated from the operating unit, so that the operation relating to a first function of the predetermined device can be carried out from the operating unit and the operation relating to a second function of the predetermined device cannot be carried out from the operating unit when the operation panel is not attached to the predetermined device, and so that at least the operation relating to the second function can be carried out from the operating unit when the operation panel is attached to the predetermined device.

### BACKGROUND OF THE INVENTION

1. Field of the Invention

The present invention relates to an operation panel which can carry out the wireless communication with a device and an information processing device having the operation panel and a main body of the information processing device.

2. Description of Related Art

In recent years, there are devices in which the operation panel is attachable to and detachable from the main body of the device and the user can carry out the various types of settings for the main body and remotely control the main body by using the operation panel at a place which is different from the installation location of the main body.

For example, in Japanese Patent Application Publication No. 2003-345500, a facsimile device comprising operation keys provided on the main body of the device and a display unit which is attachable to and detachable from the main body, is disclosed. In the facsimile device, a user can input the operation for the facsimile device from both of the operation keys and the display unit. Further, the facsimile device changes the availability/non-availability of the operation keys provided on the main body and the availability/non-availability of the display unit according to whether the display unit is attached to the main body or not.

In case that the user uses the operation panel by carrying the operation panel to a place which is different from the installation location of the main body, such as a user's seat, various types of problems are caused because the user who carries out the operation is not near the main body.

For example, in case of the multi-function peripheral for executing the confidential output of the secret document, or the like, when the operation relating to the confidential output is carried out by using the operation panel at the place which is apart from the main body, the secret document output by the main body can be seen by another person until the user arrives at the main body to receive the printed document. As a result, the problem relating to the security is caused.

On the other hand, there are some operations which are preferably carried out when the operation panel is used by carrying it to a place which is apart from the main body. For example, in case that a website can be browsed by using the operation panel, when the website is browed for a long time in a state that the operation panel is attached to the main body, the use of the operation panel by another user is interrupted.

### SUMMARY

To achieve at least one of the abovementioned objects, an operation panel reflecting one aspect of the present invention comprises:

an operating unit to receive an operation from a user;

a detecting unit to detect whether the operation panel is attached to a predetermined device;

a communication unit to be wirelessly communicable with the predetermined device; and

a control unit to switch a function of the predetermined device, which can be operated from the operating unit, so that the operation relating to a first function of the predetermined device can be carried out from the operating unit and the operation relating to a second function of the predetermined device cannot be carried out from the operating unit when the control unit recognizes that the operation panel is not attached to the predetermined device in accordance with a detection result of the detecting unit, and so that at least the operation relating to the second function can be carried out from the operating unit when the control unit recognizes that the operation panel is attached to the predetermined device in accordance with the detection result of the detecting unit.

Preferably, the control unit switches the function of the predetermined device, which can be operated from the operating unit, so that the operation relating to a third function of the predetermined device can be carried out from the operating unit when the control unit recognizes that the operation panel is not attached to the predetermined device in accordance with the detection result of the detecting unit, and so that the operation relating to the third function cannot be carried out from the operating unit when the control unit recognizes that the operation panel is attached to the predetermined device in accordance with the detection result of the detecting unit.

Preferably, the second function is a function for carrying out an authorized instruction for starting a print in a confidential job in which execution of the print is suspended in the predetermined device until the authorized instruction for starting the print is received from the operation panel.

Preferably, the third function is a web browsing function.

Preferably, the third function is a function for accessing a website other than a specific website by using a web browser.

### BRIEF DESCRIPTION OF THE DRAWINGS

The present invention will become more fully understood from the detailed description given hereinafter and the accompanying drawings given by way of illustration only, and thus are not intended as a definition of the limits of the present invention, and wherein:

FIG. 1 is an explanatory view showing an example of the configuration of the print system including the information processing device according to the embodiments;

FIG. 2 is a view showing the state in which the operation panel is detached from the information processing device;

FIG. 3 is a block diagram showing the schematic configuration of the information processing device;

FIG. 4 is a block diagram showing the schematic configuration of the operation panel;

FIG. 5 is a flowchart showing the process which is carried out when the operation panel of the information processing device according to the first embodiment receives the operation from the user;

FIG. 6 is a view showing an example of the warning message which is displayed on the display unit of the operation panel in Step S103;

FIG. 7 is a view showing an example of the warning message which is displayed on the display unit of the operation panel in Step S106;

FIG. 8 is a view showing an example of the warning message which is displayed on the display unit of the operation panel in Step S106 in case that the available website is limited to only the specific websites;

FIG. 9 is a flowchart showing the process which is carried out when the operation panel of the information processing device according to the second embodiment receives the operation from the user;

FIG. 10 is a view showing an example of the warning message which is displayed on the display unit of the operation panel in Step S203;

FIG. 11 is a view showing an example of the warning message which is displayed on the display unit of the operation panel in Step S206;

FIG. 12 is a view showing an example of the warning message which is displayed on the display unit of the operation panel in Step S206 in case that the available website is limited only to the specific websites;

FIG. 13 is a flowchart showing the process which is carried out when the operation panel of the information processing device according to the third embodiment receives the operation from the user;

FIG. 14 is a view showing an example of the warning message which is displayed on the display unit of the operation panel in Step S303;

FIG. 15 is a view showing an example of the warning message which is displayed on the display unit of the operation panel in Step S306;

FIG. 16 is a view showing an example of the warning message which is displayed on the display unit of the operation panel in Step S306 in case that the available website is limited only to the specific websites;

FIG. 17 is a flowchart showing the process which is carried out when the operation panel of the information processing device according to the fourth embodiment receives the operation from the user;

FIG. 18 is a view showing an example of the warning message which is displayed on the display unit of the operation panel in Step S403;

FIG. 19 is a view showing another example of the warning message which is displayed on the display unit of the operation panel in Step S403;

FIG. 20 is a view showing an example of the warning message which is displayed on the display unit of the operation panel in Step S406;

FIG. 21 is a view showing another example of the warning message which is displayed on the display unit of the operation panel in Step S406;

FIG. 22 is a view showing an example of the warning message which is displayed on the display unit of the operation panel in Step S406 in case that the available website is limited only to the specific websites; and

FIG. 23 is a view showing another example of the warning message which is displayed on the display unit of the operation panel in Step S406 in case that the available website is limited only to the specific websites.

### DETAILED DESCRIPTION OF PREFERRED EMBODIMENTS

Hereinafter, preferred embodiments of the present invention will be explained with reference to the accompanying drawings.

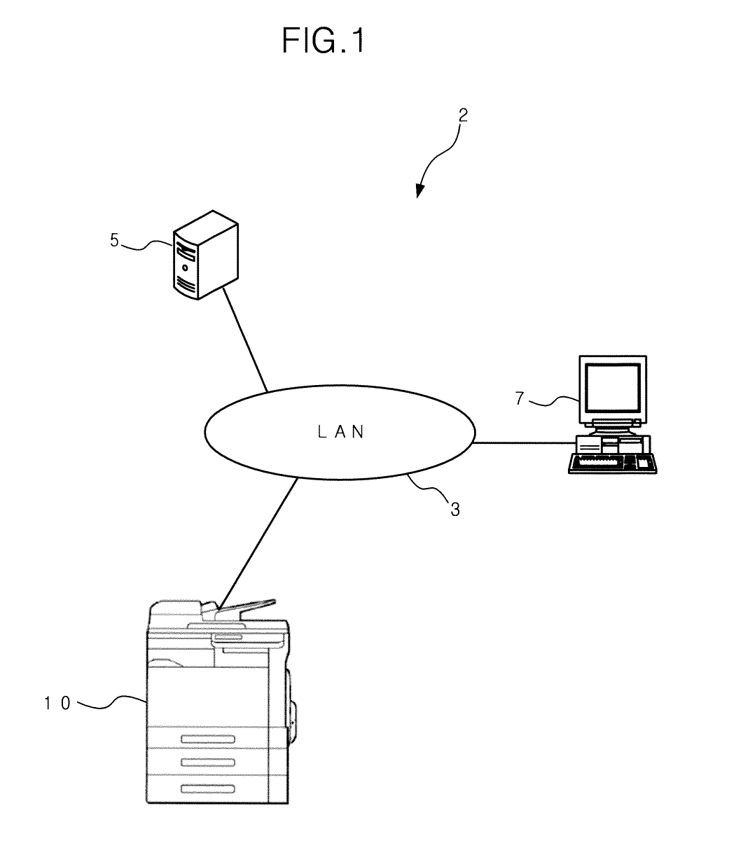

FIG. 1 shows an example of the system configuration of the print system 2 including the information processing device according to the first embodiment. The print system 2 comprises an information processing device 10, an external device 7, a print server 5 and the like so as to connect them via a network 3 such as a LAN (Local Area Network). In this embodiment, the image processing device 10 is a so-called multi-function peripheral (MFP) which has a copy function to print out an image of an original by optically reading the original, a print function to print an image in accordance with the print data received from the external device 7 or the like, a scan function to store an image data obtained by optically reading the original or the like, and a facsimile function.

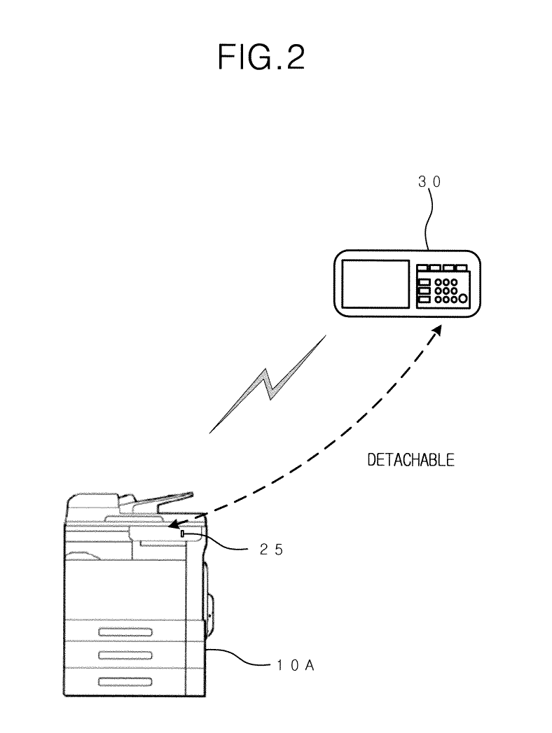

As shown in FIG. 2, the information processing device 10 comprises the operation panel 30 which is attachable to and detachable from the information processing device 10. A user can detach the operation panel 30 from the information processing device 10 and can operate the information processing device 10 by using the operation panel 30 at a place which is apart from the information processing device 10. The operation panel 30 which is detached from the main body 10A of the information processing device 10, can transmit and receive the information by the wireless communication with the main body 10A of the information processing device 10.

The functions which can be operated from the operation panel 30 can be automatically changed according to whether the operation panel 30 is attached to the main body 10A of the information processing device 10 or is detached. In the embodiment, in the state in which the operation panel 30 is detached from the main body 10A, some of the functions which the information processing device 10 has cannot be operated from the operation panel 30. Further, with respect to the specific functions, the operation panel 30 switches the availability/non-availability of the specific functions to be operated from the operation panel 30 as follows. When the operation panel 30 is attached to the main body 10A of the information processing device 10, the specific functions cannot be used from the operation panel 30. On the other hand, when the operation panel 30 is detached from the main body 10A, the specific functions can be used from the operation panel 30.

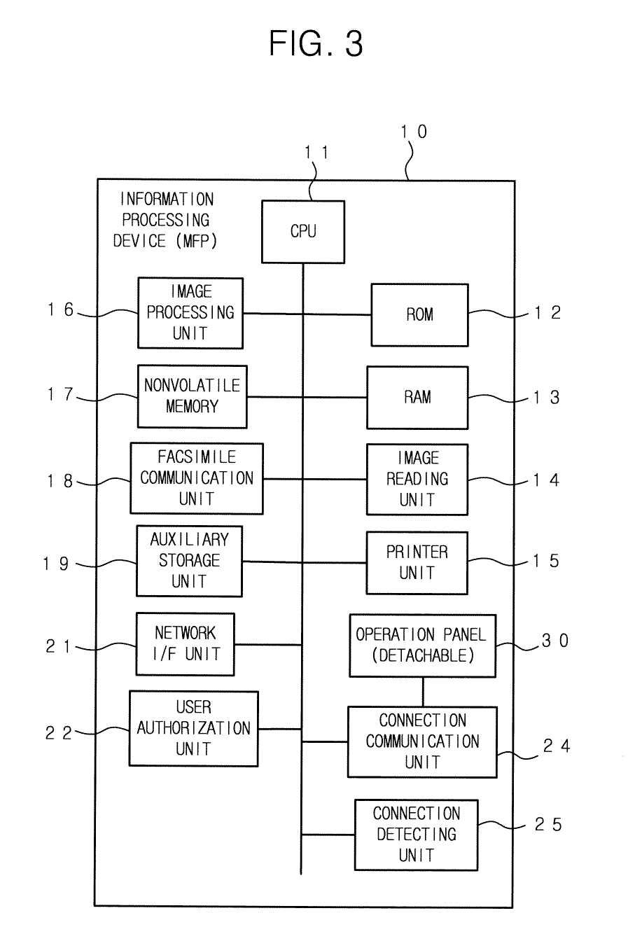

FIG. 3 shows the schematic configuration of the information processing device 10. The information processing device 10 comprises a CPU (Central Processing Unit) 11 for controlling the whole operation of the image processing device 10. The CPU 11 is connected to a ROM (Read Only Memory) 12, a RAM (Random Access Memory) 13, an image reading unit 14, a printer unit 15, an image processing unit 16, a nonvolatile memory 17, a facsimile communication unit 18, an auxiliary storage unit 19, a network I/F unit 21, a user authorization unit 22, a connection communication unit 24 and a connection detecting unit 25 via a bus. The detachable operation panel 30 is connected with the connection communication unit 24 via the communication.

By the CPU 11, a middleware, application programs and the like are executed on an OS (Operating System) program as a base. The CPU 11 functions as a control unit for controlling the operation of the information processing device 10.

In the ROM 12, various types of programs are stored. By executing the processes by the CPU 11 in accordance with these programs, each function of the information processing device 10 is realized.

The RAM 13 is used as a work memory for temporarily storing various data when the CPU 11 executes the programs and as an image memory for storing image data.

The image reading unit 14 has a function for obtaining image data by optically reading an original. For example, the image reading unit 14 comprises a light source for irradiating the original with light, a line image sensor for reading the original line by line in the width direction of the original by receiving the reflected light from the original, a moving unit for sequentially moving the reading position line by line in the longitudinal direction of the original, an optical system having lenses, mirrors and the like for guiding the reflected light from the original to the line image sensor and focusing the reflected light on the line image sensor, a converting unit for converting an analog image signal outputted from the line image sensor into digital image data, and the like.

The printer unit 15 has a function to form (print) an image on print paper in accordance with image data. In the present embodiment, the printer unit 15 is configured as an engine unit of the so-called laser printer for forming the image by the electrophotographic process. The laser printer comprises a conveying device for the recording paper, a photoconductive drum, a charging device, a laser unit, a developing device, a transfer and separation device, a cleaning device and a fixing unit. In the printer unit 15, the image may be formed by other methods.

The image processing unit 16 carries out the rasterization processing for converting print data into image data, compression/decompression processing of image data and the like, in addition to the processings, such as enlargement/reduction and rotation of the image.

The nonvolatile memory 17 is a memory (flash memory) in which the stored contents are not damaged even if the image processing device 10 is turned off. In the nonvolatile memory 17, various types of setting information and the like are stored.

The facsimile communication unit 18 has a function to transmit and receive image data to/from an external device having the facsimile function via a public line or a network.

The network I/F unit 21 has a function to communicate with the print server 5, the external device 7 and other external devices via the network 3, such as a LAN.

The user authorization unit 22 authorizes a user who uses the information processing device 10 or the operation panel 30. The user authorization is carried out by checking the combination of the user ID and the password. The authorization method to be used can be optionally selected. For example, the biometric authorization or the like can be used.

The connection communication unit 24 transmits and receives various types of information by communicating with the operation panel 30. The connection communication unit 24 comprises a connector for connecting with the connector of the operation panel 30 when the operation panel 30 is attached to the main body 10A. When the operation panel 30 is attached to the main body 10A, the main body 10A is connected with the operation panel 30 via the connector so as to communicate with each other by cable. Further, the connection communication unit 24 has a function to carry out the wireless communication with the operation panel 30. When the operation panel 30 is detached from the main body 10A, the communication for receiving and transmitting information between the main body 10A and the operation panel 30 is carried out by the wireless communication.

The connection detecting unit 25 detects whether the operation panel 30 is attached to the main body 10A or not. The connection detecting unit 25 comprises an optical sensor provided on the attachment portion of the operation panel 30 or a switch which is turned on when an actuator is pushed down by attaching the operation panel 30.

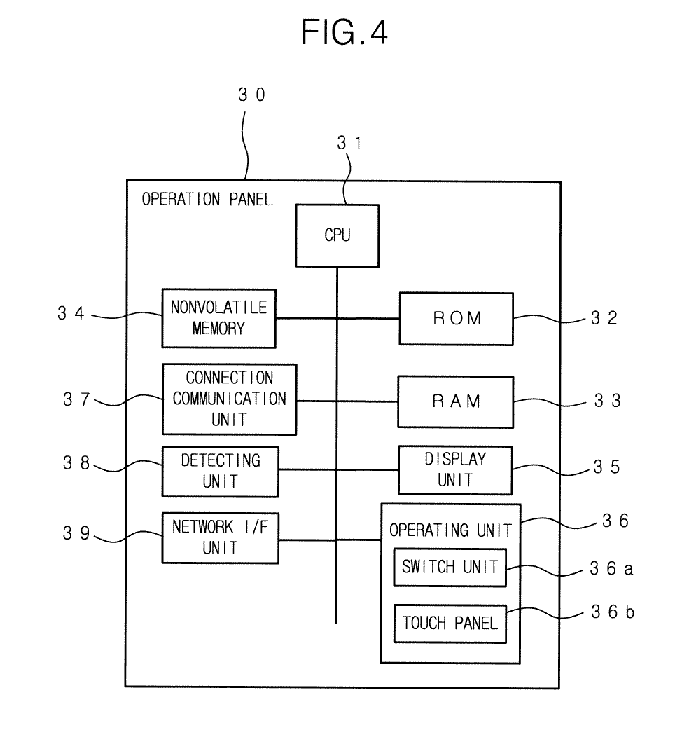

FIG. 4 shows the schematic configuration of the operation panel 30. The operation panel 30 comprises a CPU 31 for controlling the whole operation of the operation panel 30. The CPU 31 is connected to a ROM 32, a RAM 33, a nonvolatile memory 34, a display unit 35, an operating unit 36, a connection communication unit 37, a detecting unit 38 and a network I/F unit via a bus.

The CPU 31 executes various types of programs. In the ROM 32, programs and fixed data are stored. By executing the processes by the CPU 31 in accordance with the programs stored in the ROM 32, each function of the operation panel 30 is realized.

The RAM 33 is used as a work memory for temporarily storing various data when the CPU 31 executes the programs and as an video memory for the display unit 35.

The nonvolatile memory 34 is a memory (flash memory) in which the stored contents are not damaged even if the operation panel 30 is turned off. In the nonvolatile memory 34, various types of setting information and the like are stored.

The display unit 35 comprises a liquid crystal display (LCD) and the like, and has a function to display various types of operating windows, setting windows and the like. The operating unit 36 receives various types of user's operations. The operating unit 36 comprises a switch unit 36a having a numerical keypad, a start button, a selecting button for selecting a function and the like, and a touch panel 36b which is provided on the screen of the display unit 35 and detects the position coordinate at which the touch panel 36b is touched with the user's finger, a pen or the like.

The connection communication unit 37 has a function to transmit and receive various types of information to/from the main body 10A of the information processing device 10. The connection communication unit 37 comprises a connector for connecting with the connector of the main body 10A when the operation panel 30 is attached to the main body 10A. Further, the connection communication unit 37 has a function to carry out the wireless communication with the main body 10A of the information processing device 10.

The detecting unit 38 detects whether the operation panel 30 is attached to the main body 10A of the information processing device 10 or not. The detecting unit 38 comprises an optical sensor or a switch which is turned on when the operation panel 30 is attached to the main body 10A of the information processing device 10. Alternatively, by receiving the information indicating the attachment status of the operation panel 30, which is detected by the main body 10A, the operation panel 30 may recognize the attachment status.

The network I/F unit 39 has a function to communicate with the main body 10A or an external server via the network 3, such as a LAN. It is possible to browse a website and the like.

The information processing device 10 has a confidential function which is suitable for the print of the secret document or the like in the above-mentioned print function or the facsimile function. The confidential function is one for suspending the execution of the print relating to the print job received from an external terminal or the facsimile reception until the instruction for starting the print is received from the user who is authorized by using the operation panel 30. When the instruction for starting the print is received from the authorized user by using the operation panel 30, the information processing device 10 executes the suspended print relating to the print job or the facsimile reception.

As described above, the job for carrying out the print in accordance with the additional print instruction from the operation panel after the print is suspended, is referred to as the confidential job. When the confidential job is a print job, the authorized user is a user who transmits the print job. For example, by entering the specific password, the user is authorized.

Further, the information processing device 10 has the web browsing function to browse a web page by accessing the website. Various operations relating to the web browsing function are received from the operating unit 36 of the operation panel 30. The web page is displayed on the display unit 35.

Next, the process for the operations received from the operation panel 30 will be explained.

The information processing device 10 has the function (in the first embodiment, referred to as the remote limitation function and the second function corresponds to the above remote limitation function.) in which the operation received from the operation panel 30 is impossible in case that the operation panel 30 is detached from the main body 10A, but the operation received from the operation panel 30 is possible in case that the operation panel 30 is attached to the main body 10A; the function (in the first embodiment, referred to as the local limitation function and the third function corresponds to the above local limitation function.) in which the operation received from the operation panel 30 is impossible in case that the operation panel 30 is attached to the main body 10A, but the operation received from the operation panel 30 is possible in case that the operation panel 30 is detached from the main body 10A; and the function (in the first embodiment, referred to as the always permitted function) in which the operation received from the operation panel 30 is possible regardless of the attachment/detachment of the operation panel 30. Further, in the first embodiment, the first function corresponds to the function in which the operation received from the operation panel 30 is possible at least in case that the operation panel 30 is detached from the main body 10A.

In this embodiment, the remote limitation function is the confidential output function and the local limitation function is the web browsing function. The confidential output function is one for instructing the start of the print suspended by the confidential function. The other function is the always permitted function. For example, the function for setting the copy function or the function for instructing the execution of the job for transmitting the stored image by facsimile, is the always permitted function.

In the state that the operation panel 30 is detached from the main body 10A of the information processing device 10 and is apart from the main body 10A, if the CPU 31 permits the operation relating to the confidential output function, which is received by the operation panel 30, the print is started when the user who carries out the above operation is not near the main body 10A. As a result, there is some possibility that another person sees the printed document until the user arrives at the main body 10A to receive the printed document, and there are some security problems. Therefore, in the state that the operation panel 30 is detached from the main body 10A of the information processing device 10, the CPU 31 which is the control unit prohibits the operation relating to the confidential output function, which is received by the operation panel 30.

In the web browsing function, there is some possibility that the user occupies the operation panel 30 for a long time by browsing a website. As a result, another user is prevented from using the information processing device 10. Therefore, in the state that the operation panel 30 is attached to the main body 10A of the information processing device 10, the CPU 31 partially or wholly prohibits the operation relating to the web browsing function, which is carried out by using the operation panel 30.

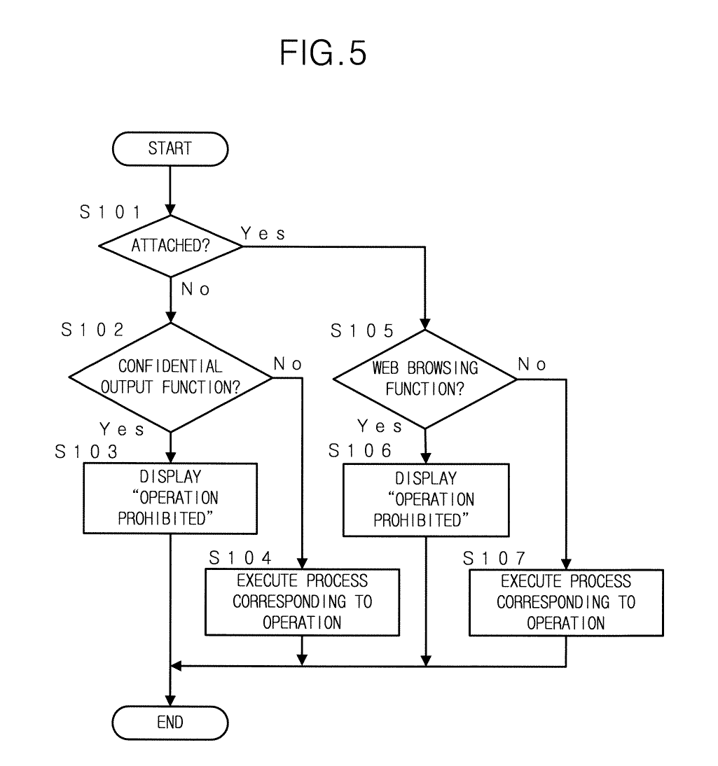

FIG. 5 shows the process which is carried out when the operation panel 30 of the information processing device 10 according to the first embodiment receives the operation from the user. When the operating unit 36 of the operation panel 30 receives the operation from the user, the CPU 31 of the operation panel 30 judges whether the operation panel 30 is attached to the main body 10A of the information processing device 10 in accordance with the detection result of the detecting unit 38 (Step S101).

In case that the operation panel 30 is detached from the main body 10A (Step S101; No), that is, in case that the detecting unit 38 detects that the operation panel 30 is not attached to the main body 10A, the CPU 31 recognizes that the operation panel 30 is not attached to the main body 10A, and judges whether the received operation is the operation relating to the remote limitation function (in this case, the confidential output function) or not (Step S102). In case of the operation relating to the confidential output function (Step S102; Yes), the CPU 31 prohibits the acceptance of the above received operation, and displays the warning massage indicating that the received operation is prohibited, on the display unit 35 (Step S103). Then, the process is ended.

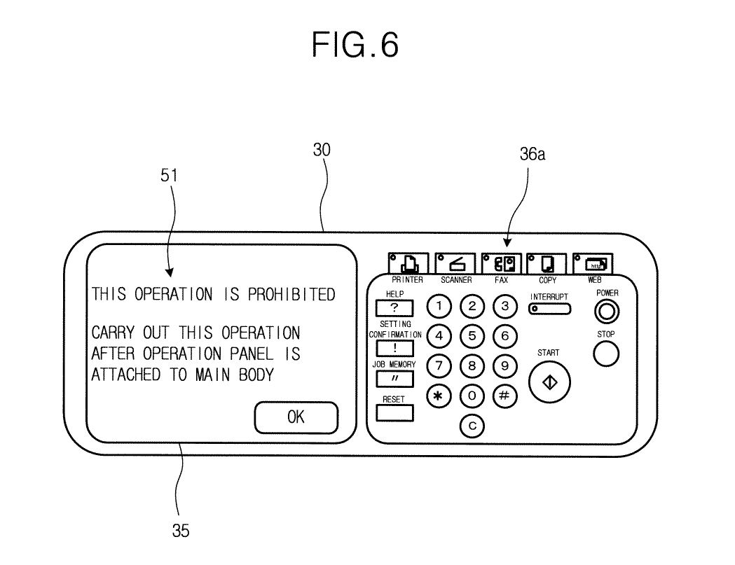

FIG. 6 shows an example of the warning massage 51 displayed on the display unit 35 of the operation panel 30 in Step S103. The operation relating to the confidential output function is permitted in the state that the operation panel 30 is attached to the main body 10A of the information processing device 10. Therefore, the CPU 31 displays the warning message 51 for prompting the user to carry out the operation relating to the confidential output function again after the operation panel 30 is attached to the main body 10A, on the display unit 35 of the operation panel 30.

On the other hand, in case that the received operation is not the operation relating to the confidential output function (Step S102; No), the CPU 31 executes the process corresponding to the received operation (Step S104). Then, the process is ended. For example, the CPU 31 transmits the contents of the received operation to the main body 10A to instruct the main body 10A to execute the process.

In case that the operation panel 30 is attached to the main body 10A (Step S101; Yes), that is, in case that the detecting unit 38 detects that the operation panel 30 is attached to the main body 10A, the CPU 31 recognizes that the operation panel 30 is attached to the main body 10A, and judges whether the received operation is the operation relating to the web browsing function which is the local limitation function (Step S105). In case of the operation relating to the web browsing function (Step S105; Yes), the CPU 31 prohibits the acceptance of the above received operation, and displays the warning message indicating that the received operation is prohibited, on the display unit 35 (Step S106). Then, the process is ended.

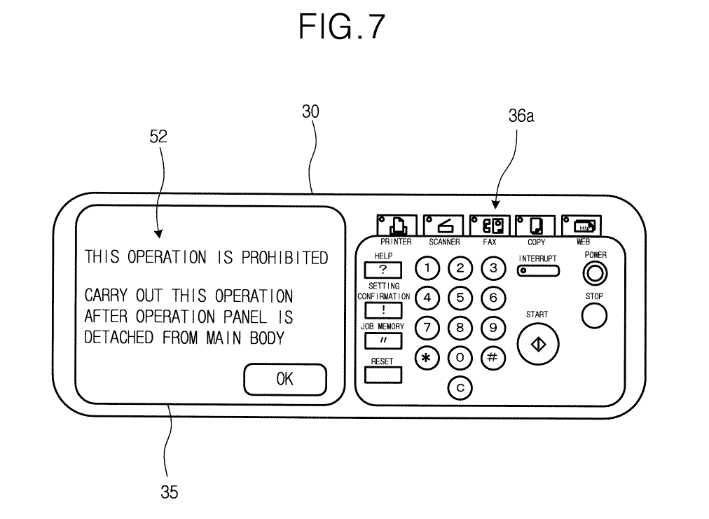

FIG. 7 shows an example of the warning massage 52 displayed on the display unit 35 of the operation panel 30 in Step S106. The operation relating to the web browsing function is permitted in the state that the operation panel 30 is detached from the main body 10A of the information processing device 10. Therefore, the CPU 31 displays the warning message 52 for prompting the user to carry out the operation relating to the web browsing function again after the operation panel 30 is detached from the main body 10A, on the display unit 35 of the operation panel 30.

In case that the received operation is not the operation relating to the web browsing function (Step S105; No in FIG. 5), the CPU 31 executes the process corresponding to the received operation (Step S107). Then, the process is ended. For example, the CPU 31 transmits the contents of the received operation to the main body 10A to instruct the main body 10A to execute the process.

The operation relating to the confidential output function, which is received from the operation panel 30 is permitted in the state that the operation panel 30 is attached to the main body 10A of the information processing device 10. Further, the operation relating to the web browsing function, which is received from the operation panel 30 is permitted in the state that the operation panel 30 is detached from the main body 10A of the information processing device 10.

The limitation of the web browsing function is carried out by prohibiting the browse of all of the websites, that is, by prohibiting the use of the web browsing function. Alternatively, for example, the available website is limited to only the specific websites. In this case, in the state that the operation panel 30 is attached to the main body 10A, the specific website can be browsed and the other websites cannot be browsed. On the other hand, in the state that the operation panel 30 is detached from the main body 10A, the above limitation is cancelled and all of the websites can be browsed.

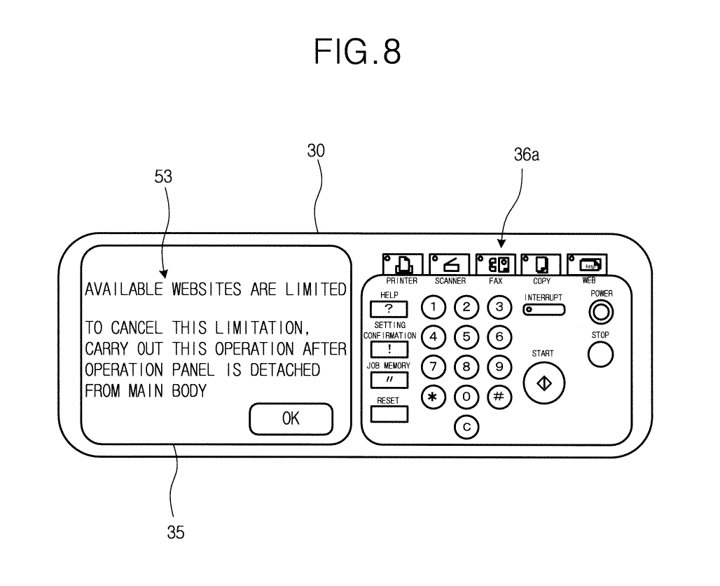

FIG. 8 shows an example of the warning message 53 displayed on the display unit 35 of the operation panel 30 in Step S106 in case that the available website is limited to only the specific websites. The limitation of the available website is cancelled in the state that the operation panel 30 is detached from the main body 10A of the information processing device 10. Therefore, the CPU 31 displays the warning message 53 for prompting the user to carry out the operation relating to the browse of the optional website again after the operation panel 30 is detached from the main body 10A, on the display unit 35 of the operation panel 30.

As described above, the CPU 31 switches the functions which can be operated from the operation panel 30, according to whether the operation panel 30 is attached to the main body 10A of the information processing device 10 or is detached from the main body 10A. Therefore, it is possible to optimize the functions which can be operated from the operation panel 30, according to each state. Further, when the user carries out the prohibited operation, the warning message for the prohibited operation is displayed. Because the user can be informed from the warning message how to carry out the above operation, the user can carry out the suitable action for the above operation by referring the warning message.

Next, the second embodiment will be explained.

In the first embodiment, the CPU 31 switches the functions which can be operated from the operation panel 30, according to whether the operation panel 30 is attached to the main body 10A or is detached from the main body 10A. In the second embodiment, the CPU 31 which is the control unit switches the functions which can be operated from the operation panel 30, according to whether the operation panel 30 is within the predetermined range (in this case, not more than 1 meter) from the main body 10A or not.

In the information processing device 10 according to the second embodiment, each of the connection detecting unit 25 of the main body 10A and the detecting unit 38 of the operation panel 30 detects whether the operation panel 30 is within the predetermined range from the main body 10A or not. For example, the above detection is carried out in accordance with the intensity of the electric wave received by the main body 10A and the operation panel 30 via the wireless communication.

Further, in the second embodiment, the information processing device 10 has the function (in the second embodiment, referred to as the remote limitation function and the second function corresponds to the above remote limitation function.) in which the operation received from the operation panel 30 is impossible in case that the operation panel 30 is not within the predetermined range from the main body 10A, but the operation received from the operation panel 30 is possible in case that the operation panel 30 is within the predetermined range from the main body 10A; the function (in the second embodiment, referred to as the local limitation function and the third function corresponds to the above local limitation function.) in which the operation received from the operation panel 30 is impossible in case that the operation panel 30 is within the predetermined range from the main body 10A, but the operation received from the operation panel 30 is possible in case that the operation panel 30 is not within the predetermined range from the main body 10A; and the function (in the second embodiment, referred to as the always permitted function) in which the operation received from the operation panel 30 is possible regardless of whether the operation panel 30 is within the predetermined range from the main body 10A or not. Further, in the second embodiment, the first function corresponds to the function in which the operation received from the operation panel 30 is possible at least in case that the operation panel 30 is not within the predetermined range from the main body 10A.

The other configurations of the information processing device 10 according to the second embodiment are basically the same as those of the information processing device 10 according to the first embodiment. The explanation of the other configurations is omitted.

In the second embodiment, the remote limitation function is the confidential output function and the local limitation function is the web browsing function (or the limitation of the available websites). The reason why the confidential output function is the remote limitation function, is as follows. In the state that the operation panel 30 is not within the predetermined range from the main body 10A of the information processing device 10 (for example, in the state that the operation panel 30 is far apart from the main body 10A), if the CPU 31 permits the operation relating to the confidential output function, which is received by the operation panel 30, there is some possibility that another person sees the printed document until the user arrives at the main body 10A to receive the printed document. Therefore, there are some security problems.

The reason why the web browsing function (or the function for limiting the available websites) is the local limitation function, is as follows. When the user occupies the operation panel 30 for a long time by browsing a website, there is some possibility that another user is prevented from using the information processing device 10.

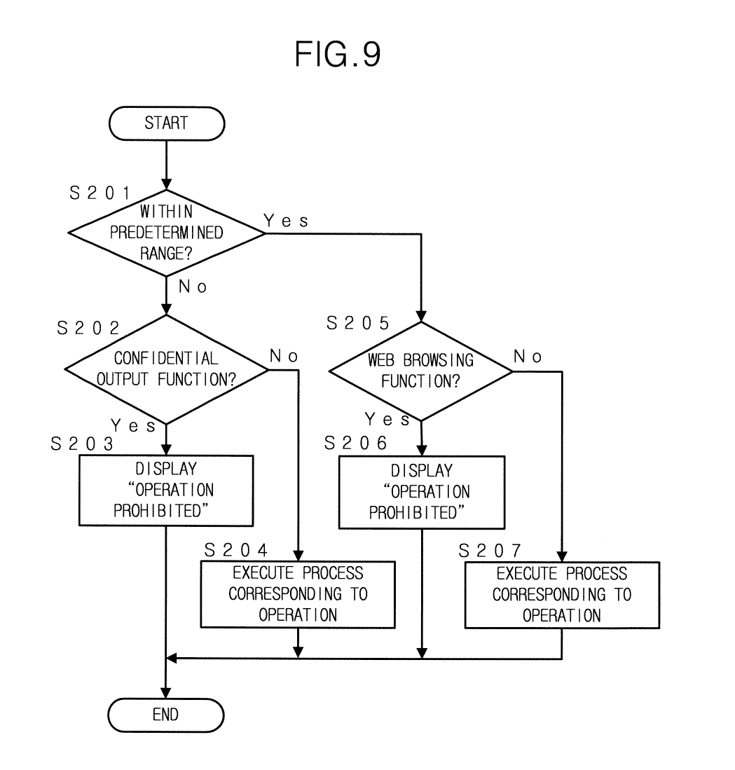

FIG. 9 shows the process which is carried out when the operation panel 30 of the information processing device 10 according to the second embodiment receives the operation from the user. When the operating unit 36 of the operation panel 30 receives the operation from the user, the CPU 31 of the operation panel 30 judges whether the operation panel 30 is within the predetermined range (for example, not less than 1 meter) from the main body 10A of the information processing device 10 in accordance with the detection result of the detecting unit 38 (Step S201).

In case that the operation panel 30 is not within the predetermined range from the main body 10A (Step S201; No), that is, in case that the detecting unit 38 detects that the operation panel 30 is not within the predetermined range from the main body 10A, the CPU 31 recognizes that the operation panel 30 is not within the predetermined range from the main body 10A, and judges whether the received operation is the operation relating to the remote limitation function (in this case, the confidential output function) or not (Step S202). In case of the operation relating to the confidential output function (Step S202; Yes), the CPU 31 prohibits the acceptance of the above received operation, and displays the warning massage indicating that the received operation is prohibited, on the display unit 35 (Step S203). Then, the process is ended.

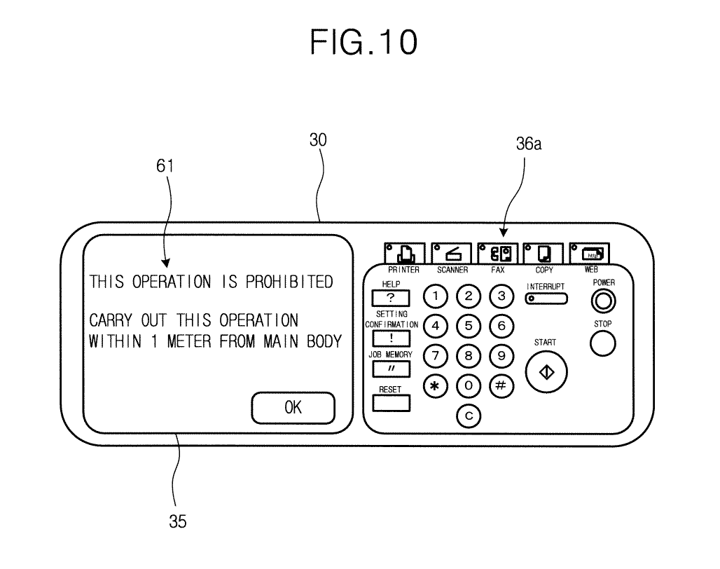

FIG. 10 shows an example of the warning massage 61 displayed on the display unit 35 of the operation panel 30 in Step S203. The operation relating to the confidential output function is permitted in the state that the operation panel 30 is within the predetermined range from the main body 10A of the information processing device 10. Therefore, the CPU 31 displays the warning message 61 for prompting the user to carry out the operation relating to the confidential output function again after the operation panel 30 is moved within the predetermined range (in this case, not more than 1 meter) from the main body 10A, on the display unit 35 of the operation panel 30.

In case that the received operation is not the operation relating to the confidential output function (Step S202; No in FIG. 9), the CPU 31 executes the process corresponding to the received operation (Step S204). Then, the process is ended. For example, the CPU 31 transmits the contents of the received operation to the main body 10A to instruct the main body 10A to execute the process.

In case that the operation panel 30 is within the predetermined range from the main body 10A (Step S201; Yes), that is, in case that the detecting unit 38 detects that the operation panel 30 is within the predetermined range from the main body 10A, the CPU 31 recognizes that the operation panel 30 is within the predetermined range from the main body 10A, and judges whether the received operation is the operation relating to the web browsing function which is the local limitation function (Step S205). In case of the operation relating to the web browsing function (Step S205; Yes), the CPU 31 prohibits the acceptance of the above received operation, and displays the warning message indicating that the received operation is prohibited, on the display unit 35 (Step S206). Then, the process is ended.

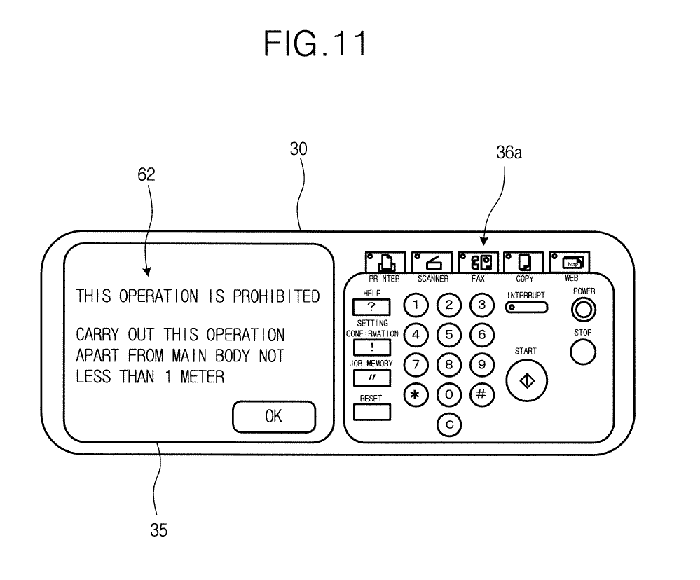

FIG. 11 shows an example of the warning massage 62 displayed on the display unit 35 of the operation panel 30 in Step S206. The operation relating to the web browsing function is permitted in the state that the operation panel 30 is apart from the main body 10A of the information processing device 10 outside the predetermined range. Therefore, the CPU 31 displays the warning message 62 for prompting the user to carry out the operation relating to the web browsing function again in the state that the operation panel 30 is apart from the main body 10A outside the predetermined range, on the display unit 35 of the operation panel 30.

In case that the limitation of the web browsing function is the limitation of the available website (that is, the available website is limited to the specific websites), in Step S205, the CPU 31 judges whether the operation received from the user is the operation for browsing a website other than the available website. In case that the received operation is the operation for browsing a website other than the available websites, the CPU 31 selects “Yes” in Step S205 and the process proceeds to Step S206.

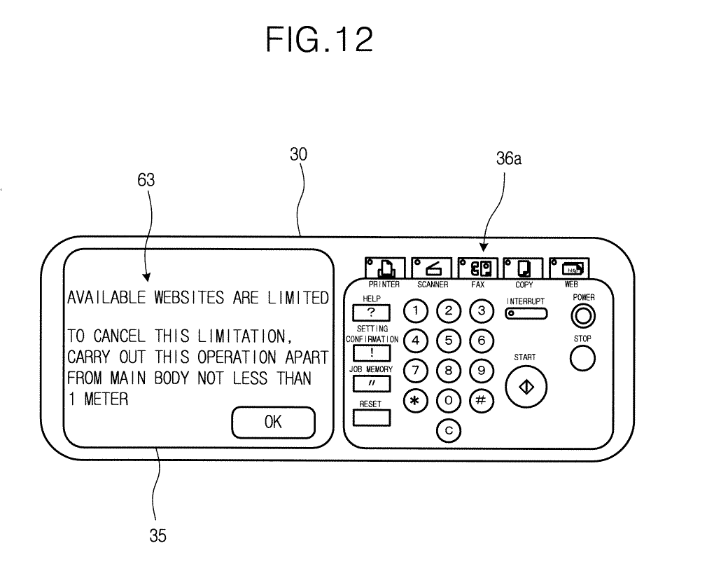

FIG. 12 shows an example of the warning message 63 displayed on the display unit 35 of the operation panel 30 in Step S206 in case that the limitation of the web browsing function is the limitation of the available website. The limitation of the available website is cancelled in the state that the operation panel 30 is not within the predetermined range from the main body 10A of the information processing device 10. Therefore, the CPU 31 displays the warning message 63 for prompting the user to carryout the operation for browsing the website again in the state that the operation panel 30 is apart from the main body 10A over 1 meter, on the display unit 35 of the operation panel 30.

In case that the operation received from the user is not the operation relating to the web browsing function (or the operation for browsing a website other than the available website) (Step S205; No), the CPU 31 executes the process corresponding to the received operation (Step S207). Then, the process is ended. For example, the CPU 31 transmits the contents of the received operation to the main body 10A to instruct the main body 10A to execute the process.

The operation relating to the confidential output function, which is received from the operation panel 30 is permitted in the state that the operation panel 30 is within the predetermined range from the main body 10A of the information processing device 10. Further, the operation relating to the web browsing function (or the operation for browsing a website other than the available website), which is received from the operation panel 30 is permitted in the state that the operation panel 30 is not within the predetermined range from the main body 10A of the information processing device 10.

As described above, the CPU 31 switches the functions which can be operated from the operation panel 30, according to whether the operation panel 30 is within the predetermined range from the main body 10A of the information processing device 10 or not. Therefore, it is possible to optimize the functions which can be operated from the operation panel 30, according to each state. Further, when the user carries out the prohibited operation, the warning message for the prohibited operation is displayed. Because the user can be informed from the warning message how to carry out the above operation, the user can carry out the suitable action for the above operation by referring the warning message.

Next, the third embodiment will be explained.

In the first embodiment, the CPU 31 switches the functions which can be operated from the operation panel 30, according to whether the operation panel 30 is attached to the main body 10A or is detached from the main body 10A. In the third embodiment, the CPU 31 which is the control unit switches the functions which can be operated from the operation panel 30, according to whether the communication between the operation panel 30 and the main body 10A is the wireless communication or the cable communication.

In the information processing device 10 according to the third embodiment, each of the connection communication unit 24 of the main body 10A and the connection communication unit 37 of the operation panel 30 has a first communication unit for carrying out the cable communication as a first communication method, and a second communication unit for carrying out the wireless communication as a second communication method. In this embodiment, the cable communication may be a cable communication which is established via the connector of the operation panel 30 and the connector of the main body 10A which are connected with each other when the operation panel 30 is attached to the main body 10A. Further, for example, the cable communication may be established by connecting them via a cable having a length of about 1 meter. The cable communication may be established by using a cable LAN.

Each of the connection detecting unit 25 of the main body 10A and the detecting unit 38 of the operation panel 30 detects whether the communication between the operation panel 30 and the main body 10A is established by the wireless communication or by the cable communication. The cable communication is established in priority to the wireless communication.

Further, in the third embodiment, the information processing device 10 has the function (in the third embodiment, referred to as the remote limitation function and the second function corresponds to the above remote limitation function.) in which the operation received from the operation panel 30 is impossible incase that the communication (cable communication) between the main body 10A and the operation panel 30 via each first communication unit is not established and the communication (wireless communication) between the main body 10A and the operation panel 30 via each second communication unit is established, but the operation received from the operation panel 30 is possible in case that the communication between the main body 10A and the operation panel 30 via each first communication unit is established; the function (in the third embodiment, referred to as the local limitation function and the third function corresponds to the above local limitation function.) in which the operation received from the operation panel 30 is impossible in case that the communication using each first communication unit is established, but the operation received from the operation panel 30 is possible in case that the communication using each first communication unit is not established and the communication using each second communication unit is established; and the function (in the third embodiment, referred to as the always permitted function) in which the operation received from the operation panel 30 is possible regardless of whether the communication using each first communication unit is established or not. Further, in the third embodiment, the first function corresponds to the function in which the operation received from the operation panel 30 is possible at least in case that the communication between the main body 10A and the operation panel 30 via each first communication unit is not established and the communication between the main body 10A and the operation panel 30 via each second communication unit is established.

The other configurations of the information processing device 10 according to the third embodiment are basically the same as those of the information processing device 10 according to the first embodiment. The explanation of the other configurations is omitted.

In the third embodiment, the remote limitation function is the confidential output function and the local limitation function is the web browsing function (or the limitation of the available websites). That is, in case that the wireless communication is established, because the operation panel 30 is detached from the main body 10A of the information processing device 10 and the operation panel 30 is used apart from the main body 10A, the confidential output function is treated as the remote limitation function. Further, in case that the cable communication is established, because the operation panel 30 is used by attaching the operation panel 30 to the main body 10A or by connecting the operation panel 30 with the main body 10A by a cable near the main body 10A, the web browsing function (or the function for limiting the available website) is treated as the local limitation function.

The cable communication has the high security on the communication as compared with the wireless communication. Therefore, the operation relating to the function which requires the high security on the communication may be prohibited in the state that the wireless communication is established. For example, the operation relating to the function for setting and registering a password is prohibited in the state that the wireless communication is established.

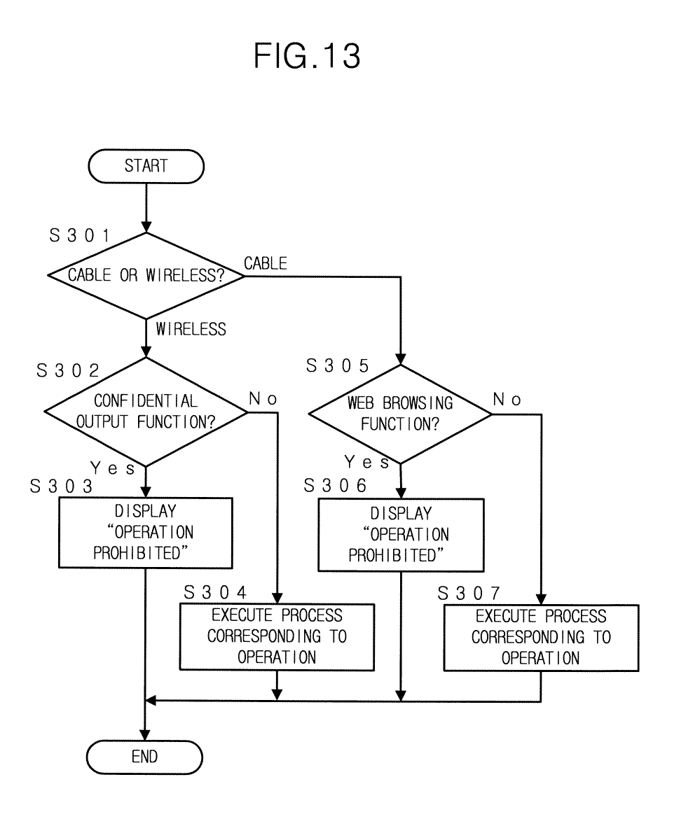

FIG. 13 shows the process which is carried out when the operation panel 30 of the information processing device 10 according to the third embodiment receives the operation from the user. When the operating unit 36 of the operation panel 30 receives the operation from the user, the CPU 31 of the operation panel 30 judges whether the wireless communication between the operation panel 30 and the main body 10A of the information processing device 10 is established or the cable communication is established in accordance with the detection result of the detecting unit 38 (Step S301).

In case that the wireless communication is established (Step S301; wireless), that is, in case that the communication using the first communication unit is not established and the communication using the second communication unit is established, the CPU 31 judges whether the received operation is the operation relating to the remote limitation function (in this case, the confidential output function) or not (Step S302). In case of the operation relating to the confidential output function (Step S302; Yes), the CPU 31 prohibits the acceptance of the above received operation, and displays the warning massage indicating that the received operation is prohibited, on the display unit 35 (Step S303). Then, the process is ended.

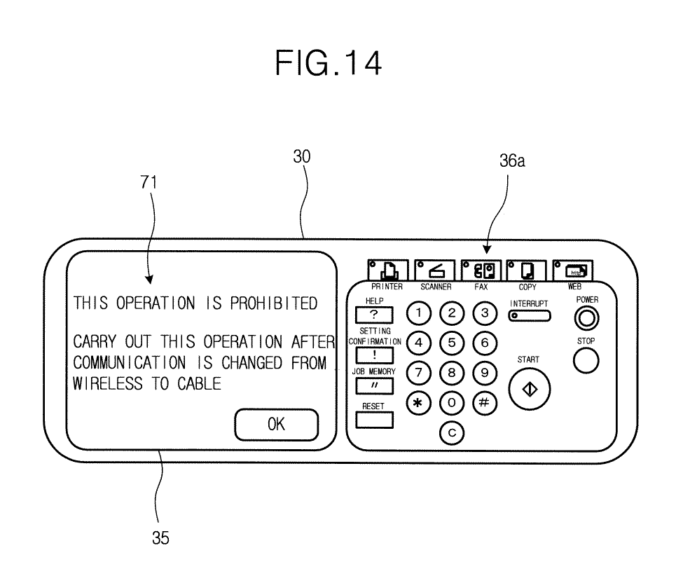

FIG. 14 shows an example of the warning massage 71 displayed on the display unit 35 of the operation panel 30 in Step S303. The operation relating to the confidential output function is permitted in the state that the cable communication between the operation panel 30 and the main body 10A of the information processing device 10 is established. Therefore, the CPU 31 displays the warning message 71 for prompting the user to carry out the operation relating to the confidential output function again after the communication method for communicating between the operation panel 30 and the main body 10A is switched from the wireless communication to the cable communication, on the display unit 35 of the operation panel 30.

In case that the received operation is not the operation relating to the confidential output function (Step S302; No in FIG. 13), the CPU 31 executes the process corresponding to the received operation (Step S304). Then, the process is ended. For example, the CPU 31 transmits the contents of the received operation to the main body 10A to instruct the main body 10A to execute the process.

In case that the cable communication between the operation panel 30 and the main body 10A is established (Step S301; cable), that is, in case that the communication using the first communication unit is established, the CPU 31 judges whether the received operation is the operation relating to the web browsing function which is the local limitation function (Step S305). In case of the operation relating to the web browsing function (Step S305; Yes), the CPU 31 prohibits the acceptance of the above received operation, and displays the warning message indicating that the received operation is prohibited, on the display unit 35 (Step S306). Then, the process is ended.

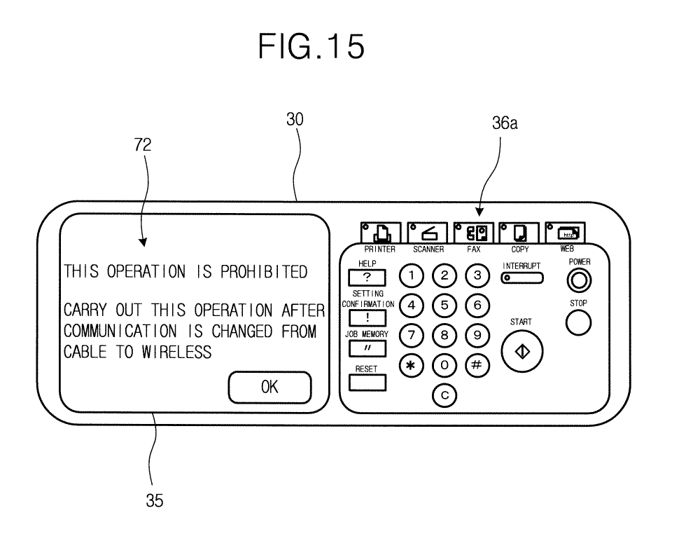

FIG. 15 shows an example of the warning massage 72 displayed on the display unit 35 of the operation panel 30 in Step S306. The operation relating to the web browsing function is permitted in the state that the communication between the operation panel 30 and the main body 10A of the information processing device 10 is the wireless communication. Therefore, the CPU 31 displays the warning message 72 for prompting the user to carry out the operation relating to the web browsing function again after the communication method for communicating between the operation panel 30 and the main body 10A is switched to the wireless communication, on the display unit 35 of the operation panel 30.

In case that the limitation of the web browsing function is the limitation of the available website, in Step S305, the CPU 31 judges whether the operation received from the user is the operation for browsing a website other than the available website. In case that the received operation is the operation for browsing a website other than the available websites, the CPU 31 selects “Yes” in Step S305 and the process proceeds to Step S306.

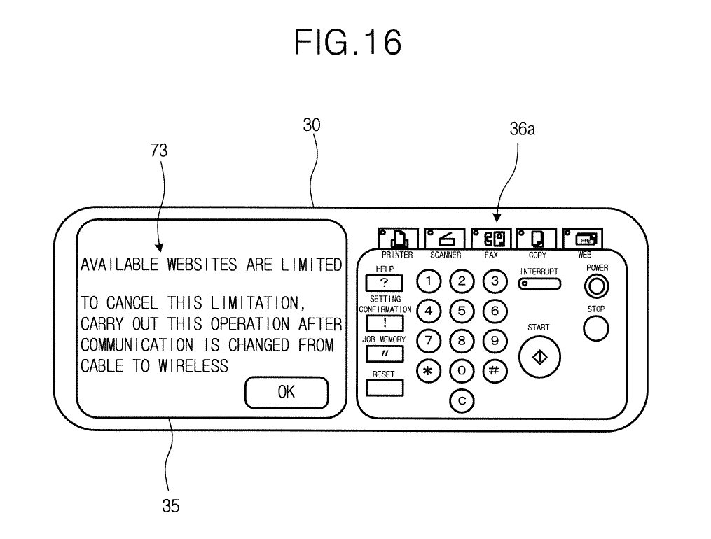

FIG. 16 shows an example of the warning message 73 displayed on the display unit 35 of the operation panel 30 in Step S306 in case that the limitation of the web browsing function is the limitation of the available website. The limitation of the available website is cancelled in the state that the wireless communication between the operation panel 30 and the main body 10A of the information processing device 10 is established. Therefore, the CPU 31 displays the warning message 73 for prompting the user to carry out the operation for browsing the website again after the communication method for communicating between the operation panel 30 and the main body 10A is switched from the cable communication to the wireless communication, on the display unit 35 of the operation panel 30.

In case that the operation received from the user is not the operation relating to the web browsing function (or the operation for browsing a website other than the available website) (Step S305; No), the CPU 31 executes the process corresponding to the received operation (Step S307). Then, the process is ended. For example, the CPU 31 transmits the contents of the received operation to the main body 10A to instruct the main body 10A to execute the process.

The operation relating to the confidential output function, which is received from the operation panel 30 is permitted in the state that the cable communication between the operation panel 30 and the main body 10A of the information processing device 10 is established. Further, the operation relating to the web browsing function (or the operation for browsing a website other than the available website), which is received from the operation panel 30 is permitted in the state that the wireless communication between the operation panel 30 and the main body 10A of the information processing device 10 is established.

As described above, the CPU 31 switches the functions which can be operated from the operation panel 30, according to whether the wireless communication between the operation panel 30 and the main body 10A of the information processing device 10 is established or the cable communication is established. Therefore, it is possible to optimize the functions which can be operated from the operation panel 30, according to each state. Further, when the user carries out the prohibited operation, the warning message for the prohibited operation is displayed. Because the user can be informed from the warning message how to carry out the above operation, the user can carry out the suitable action for the above operation by referring the warning message.

Next, the fourth embodiment will be explained.

In the third embodiment, the CPU 31 switches the functions which can be operated from the operation panel 30, according to whether the communication between the operation panel 30 and the main body 10A is the wireless communication or the cable communication. In the fourth embodiment, the CPU 31 which is the control unit switches the functions which can be operated from the operation panel 30, according to whether the communication between the operation panel 30 and the main body 10A is the short-distance wireless communication or the wireless communication (referred to as the second wireless communication) other than the short-distance wireless communication.

In the information processing device 10 according to the fourth embodiment, each of the connection communication unit 24 of the main body 10A and the connection communication unit 37 of the operation panel 30 has a first communication unit for carrying out the short-distance wireless communication as a first communication method, and a second communication unit for carrying out the wireless communication other than the short-distance wireless communication as a second communication method.

It is preferable that the short-distance wireless communication having the communication range of about 1 meter is used. However, the short-distance wireless communication having the communication range of not more than 10 meters is permitted. In this embodiment, in the short-distance wireless communication, Bluetooth® is used. In the second wireless communication, Wi-Fi® is used. However, the communication methods are not limited to these. In case of Bluetooth®, class 3 (1 mW, range: 1 meter) is preferable. Further, Bluetooth® having class 2 can be used according to the circumstances. However, Bluetooth® having class 1 cannot be used as the short-distance wireless communication.

Each of the connection detecting unit 25 of the main body 10A and the detecting unit 38 of the operation panel 30 detects whether the short-distance wireless communication between the operation panel 30 and the main body 10A is established or the second wireless communication is established. The short-distance wireless communication is established in priority to the second wireless communication.

Further, in the fourth embodiment, the information processing device 10 has the function (in the fourth embodiment, referred to as the remote limitation function and the second function corresponds to the above remote limitation function.) in which the operation received from the operation panel 30 is impossible in case that the communication (short-distance wireless communication) between the main body 10A and the operation panel 30 via each first communication unit is not established and the communication (second wireless communication other than the short-distance wireless communication) between the main body 10A and the operation panel 30 via each second communication unit is established, but the operation received from the operation panel 30 is possible in case that the communication between the main body 10A and the operation panel 30 via each first communication unit is established; the function (in the fourth embodiment, referred to as the local limitation function and the third function corresponds to the above local limitation function.) in which the operation received from the operation panel 30 is impossible in case that the communication using each first communication unit is established, but the operation received from the operation panel 30 is possible in case that the communication using each first communication unit is not established and the communication using each second communication unit is established; and the function (in the fourth embodiment, referred to as the always permitted function) in which the operation received from the operation panel 30 is possible regardless of whether the communication using each first communication unit is established or not. Further, in the fourth embodiment, the first function corresponds to the function in which the operation received from the operation panel 30 is possible at least in case that the communication between the main body 10A and the operation panel 30 via each first communication unit is not established and the communication between the main body 10A and the operation panel 30 via each second communication unit is established.

Alternatively, regardless of whether the short-distance wireless communication is actually established, the detecting unit 38 or the like may detect whether the short-distance wireless communication can be established. That is, at the place where the short-distance wireless communication can be established, the second wireless communication can be also established. In practice, it is assumed that the second wireless communication is established in accordance with the user's selection. Therefore, the detecting unit 38 or the like detects not whether the short-distance wireless communication is actually established or not, but whether the short-distance wireless communication can be established. In this case, the remote limitation function is the function in which the operation received from the operation panel 30 is impossible in case that the communication (short-distance wireless communication) between the main body 10A and the operation panel 30 via each first communication unit cannot be established and the communication (second wireless communication other than the short-distance wireless communication) between the main body 10A and the operation panel 30 via each second communication unit is established, but the operation received from the operation panel 30 is possible in case that the communication between the main body 10A and the operation panel 30 via each first communication unit can be established. Further, the local limitation function is the function in which the operation received from the operation panel 30 is impossible in case that the communication using each first communication unit can be established, but the operation received from the operation panel 30 is possible in case that the communication using each first communication unit cannot be established and the communication using each second communication unit is established.

The other configurations of the information processing device 10 according to the fourth embodiment are basically the same as those of the information processing device 10 according to the first embodiment. The explanation of the other configurations is omitted.

In the fourth embodiment, the remote limitation function is the confidential output function and the local limitation function is the web browsing function (or the limitation of the available websites). That is, in case that the short-distance wireless communication is not established or cannot be established, because the operation panel 30 is used apart from the main body 10A of the information processing device 10, the confidential output function is treated as the remote limitation function. Further, incase that the short-distance wireless communication is established or can be established, because the operation panel 30 is used by attaching the operation panel 30 to the main body 10A of the information processing device 10 or the operation panel 30 is used near the main body 10A, the web browsing function (or the function for limiting the available website) is treated as the local limitation function.

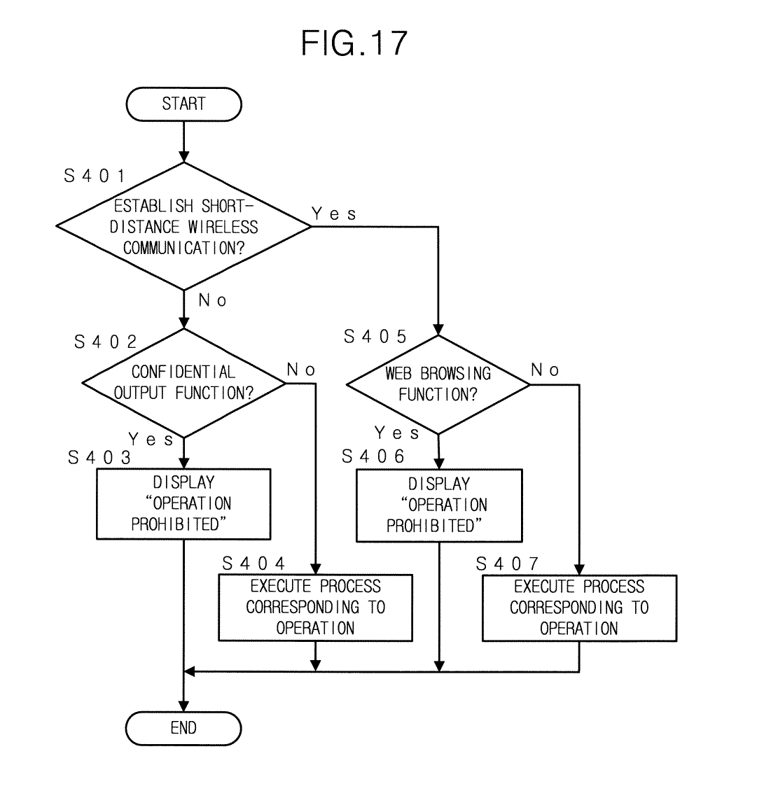

FIG. 17 shows the process which is carried out when the operation panel 30 of the information processing device 10 according to the fourth embodiment receives the operation from the user. When the operating unit 36 of the operation panel 30 receives the operation from the user, the CPU 31 of the operation panel 30 judges whether the short-distance wireless communication between the operation panel 30 and the main body 10A of the information processing device 10 is established (can be established) in accordance with the detection result of the detecting unit 38 (Step S401).

In case that the short-distance wireless communication is not established (cannot be established) (Step S401; No), that is, in case that the communication using the first communication unit is not established (cannot be established) and the communication using the second communication unit is established, the CPU 31 judges whether the received operation is the operation relating to the remote limitation function (in this case, the confidential output function) or not (Step S402). In case of the operation relating to the confidential output function (Step S402; Yes), the CPU 31 prohibits the acceptance of the above received operation, and displays the warning massage indicating that the received operation is prohibited, on the display unit 35 (Step S403). Then, the process is ended.

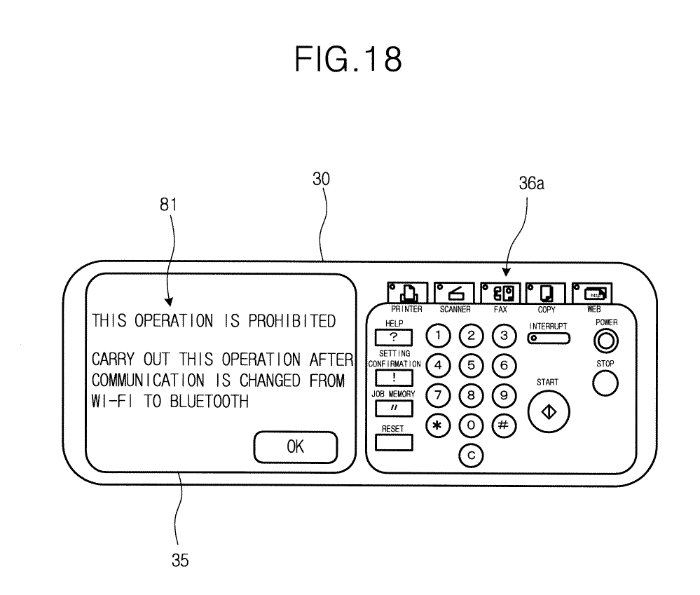

FIG. 18 shows an example of the warning massage 81 displayed on the display unit 35 of the operation panel 30 in Step S403. The operation relating to the confidential output function is permitted in the state that the short-distance wireless communication between the operation panel 30 and the main body 10A of the information processing device 10 is established (or can be established). Therefore, the CPU 31 displays the warning message 81 for prompting the user to carry out the operation relating to the confidential output function again after the communication method for communicating between the operation panel 30 and the main body 10A is switched from the second wireless communication (in this example, Wi-Fi®) to the short-distance wireless communication (in this example, Bluetooth®), on the display unit 35 of the operation panel 30.

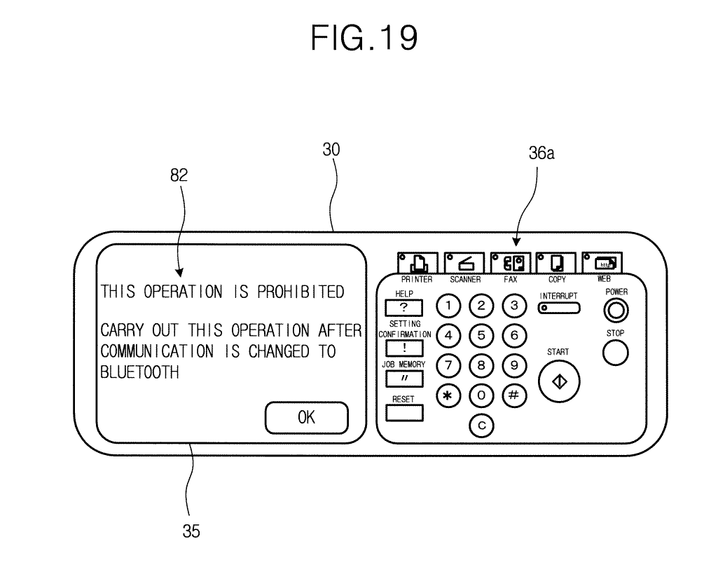

FIG. 19 shows another example of the warning massage 82 displayed on the display unit 35 of the operation panel 30 in Step S403. In FIG. 19, the CPU 31 displays the warning message 82 for prompting the user to carry out the operation relating to the confidential output function again after the communication method for communicating between the operation panel 30 and the main body 10A is switched to the short-distance wireless communication (in this example, Bluetooth®), on the display unit 35 of the operation panel 30.

In case that the received operation is not the operation relating to the confidential output function (Step S402; No in FIG. 17), the CPU 31 executes the process corresponding to the received operation (Step S404). Then, the process is ended. For example, the CPU 31 transmits the contents of the received operation to the main body 10A to instruct the main body 10A to execute the process.

In case that the short-distance wireless communication between the operation panel 30 and the main body 10A is established (or can be established) (Step S401; Yes), the CPU 31 judges whether the received operation is the operation relating to the web browsing function which is the local limitation function (Step S405). In case of the operation relating to the web browsing function (Step S405; Yes), the CPU 31 prohibits the acceptance of the above received operation, and displays the warning message indicating that the received operation is prohibited, on the display unit 35 (Step S406). Then, the process is ended.

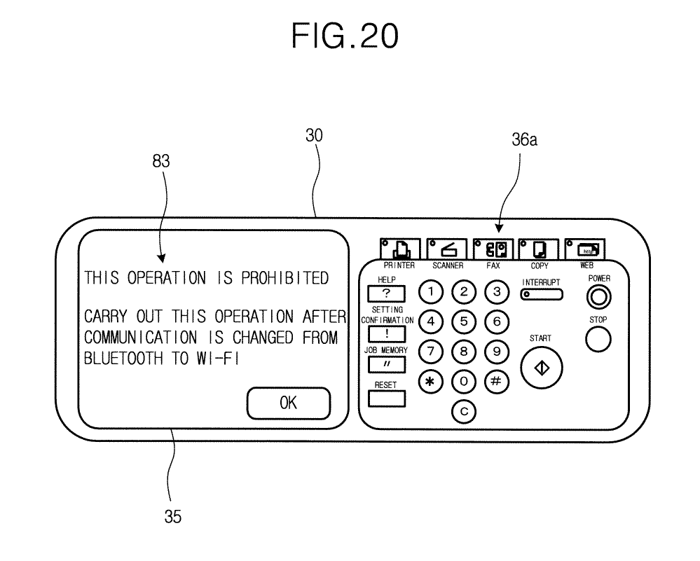

FIG. 20 shows an example of the warning massage 83 displayed on the display unit 35 of the operation panel 30 in Step S406. The operation relating to the web browsing function is permitted in the state that the second wireless communication (in this example, Wi-Fi®) between the operation panel 30 and the main body 10A of the information processing device 10 is established (or can be established). Therefore, the CPU 31 displays the warning message 83 for prompting the user to carry out the operation relating to the web browsing function again after the communication method for communicating between the operation panel 30 and the main body 10A is switched from the short-distance wireless communication (in this example, Bluetooth®) to the second wireless communication (in this example, Wi-Fi®), on the display unit 35 of the operation panel 30.

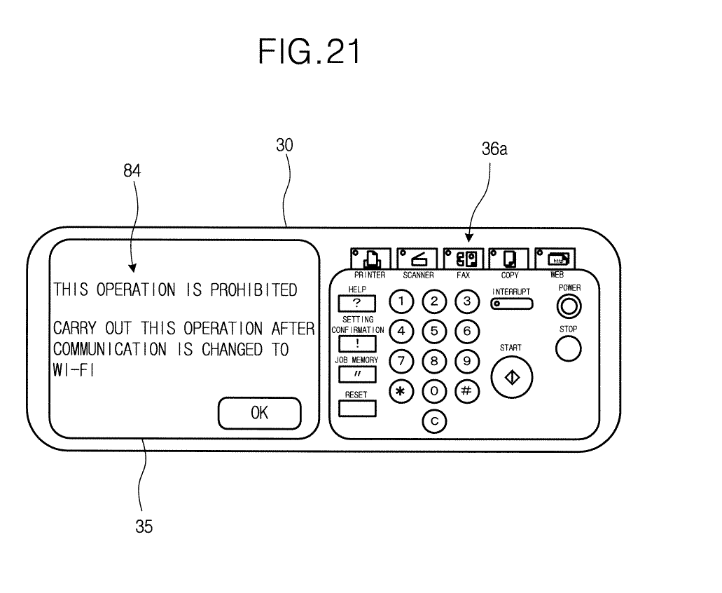

FIG. 21 shows another example of the warning massage 84 displayed on the display unit 35 of the operation panel 30 in Step S406. In FIG. 21, the CPU 31 displays the warning message 84 for prompting the user to carry out the operation relating to the web browsing function again after the communication method for communicating between the operation panel 30 and the main body 10A is switched to the second wireless communication (in this example, Wi-Fi®)), on the display unit 35 of the operation panel 30.

In case that the limitation of the web browsing function is the limitation of the available website to the specific websites, in Step S405, the CPU 31 judges whether the operation received from the user is the operation for browsing a website other than the available website. In case that the received operation is the operation for browsing a website other than the available web sites, the CPU 31 selects “Yes” in Step S405 and the process proceeds to Step S406.

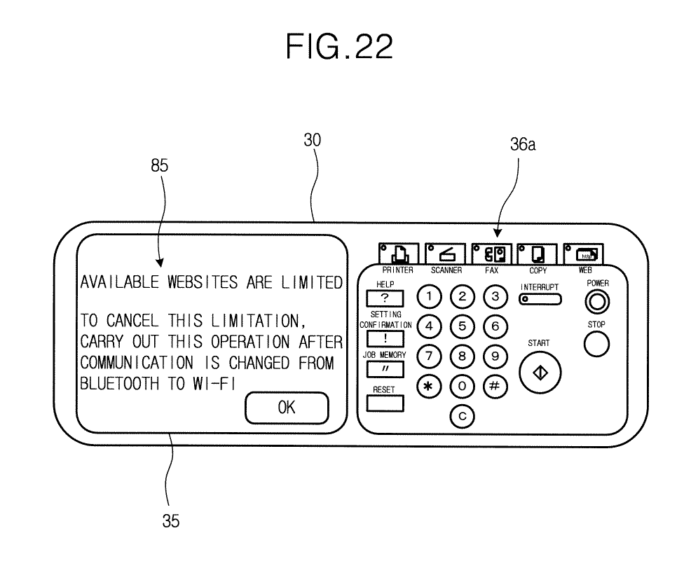

FIG. 22 shows an example of the warning message 85 displayed on the display unit 35 of the operation panel 30 in Step S406 in case that the limitation of the web browsing function is the limitation of the available website to the specific websites. The limitation of the available website is cancelled in the state that the second wireless communication (in this example, Wi-Fi®) between the operation panel 30 and the main body 10A of the information processing device 10 is established. Therefore, the CPU 31 displays the warning message 85 for prompting the user to carry out the operation for browsing the website again after the communication method for communicating between the operation panel 30 and the main body 10A is switched from the short-distance wireless communication (in this example, Bluetooth®) to the second wireless communication (in this example, Wi-Fi®), on the display unit 35 of the operation panel 30.

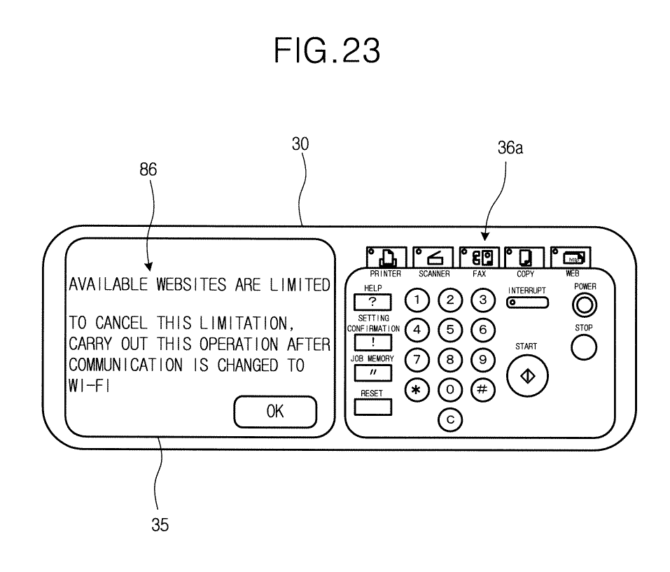

FIG. 23 shows another example of the warning message 86 displayed on the display unit 35 of the operation panel 30 in Step S406 in case that the limitation of the web browsing function is the limitation of the available website to the specific websites. The CPU 31 displays the warning message 86 for prompting the user to carry out the operation for browsing the website again after the communication method for communicating between the operation panel 30 and the main body 10A is switched to the second wireless communication (in this example, Wi-Fi®), on the display unit 35 of the operation panel 30.

In case that the operation received from the user is not the operation relating to the web browsing function (or the operation for browsing a website other than the available website) (Step S405; No in FIG. 17), the CPU 31 executes the process corresponding to the received operation (Step S407). Then, the process is ended. For example, the CPU 31 transmits the contents of the received operation to the main body 10A to instruct the main body 10A to execute the process.

The operation relating to the confidential output function, which is received from the operation panel 30 is permitted in the state that the short-distance wireless communication between the operation panel 30 and the main body 10A of the information processing device 10 is established (or can be established). Further, the operation relating to the web browsing function (or the operation for browsing a website other than the available website), which is received from the operation panel 30 is permitted in the state that the second wireless communication (wireless communication other than the short-distance wireless communication) between the operation panel 30 and the main body 10A of the information processing device 10 is established (or can be established).

As described above, the CPU 31 switches the functions which can be operated from the operation panel 30, according to whether the short-distance wireless communication between the operation panel 30 and the main body 10A of the information processing device 10 is established (or can be established) or not. Therefore, it is possible to optimize the functions which can be operated from the operation panel 30, according to whether the operation panel 30 is near the main body 10A or not. Further, when the user carries out the prohibited operation, the warning message for the prohibited operation is displayed. Because the user can be informed from the warning message how to carry out the above operation, the user can carry out the suitable action for the above operation by referring the warning message.

As described above, the embodiments are explained by using the drawings. However, in the present invention, the concrete configuration is not limited to the above embodiments. In the present invention, various modifications of the above embodiments or the addition of various functions or the like to the embodiments can be carried out without departing from the gist of the invention.

In the above embodiments, because the CPU 31 of the operation panel 30 carries out the process for switching the function which can be operated from the operation panel 30 (processes shown in FIGS. 5, 9, 13 and 17), the main body 10A is not required to carry out the process for switching the function which can be operated. However, the main body 10A may switch the operation of the information processing device 10 in accordance with the detection result of the connection detecting unit 25 of the information processing device 10, which indicates the attachment state of the operation panel 30. Further, in case that the main body 10A transmits the detection result of the connection detecting unit 25 to the operation panel 30 via the communication, the detecting unit 38 of the operation panel 30 can be omitted.

In each embodiment, the CPU 31 of the operation panel 31 carries out the process for switching the function which can be operated from the operation panel 30 (processes shown in FIGS. 5, 9, 13 and 17). However, the main body 10A of the information processing device 10 may carry out the above process. For example, the information processing device 10 may have the following configuration. In this configuration, the operation panel 30 transmits the contents of the operation received from the operation panel 30 to the main body 10A. Then, the main body 10A of the information processing device 10 judges whether the received operation is prohibited and transmits the above judgment result to the operation panel 30. When the operation panel 30 receives the judgment result, the operation panel 30 permits the operation or prohibits the operation and displays the warning message in accordance with the received judgment result.

Further, the information processing device 10 may have the following configuration. In this configuration, the main body 10A of the information processing device 10 functions as a server for controlling the display contents to be displayed by the operation panel 30 and for controlling the process for permitting the operation. The operation panel 30 functions as a client for displaying the setting window and the like in accordance with the window data received from the main body 10A and for transmitting the setting contents to the main body 10A. In this case, the main body 10A of the information processing device 10 carries out the process for switching the function which can be operated from the operation panel 30 (processes shown in FIGS. 5, 9, 13 and 17).

In the above embodiments, the remote limitation function is the confidential output function and the local limitation function is the web browsing function or the function for limiting the available website to the specific websites. However, these functions are simply exemplified. The functions are not limited to these.

Further, in the above embodiments, the case in which the information processing device 10 is the multi-function peripheral, is explained. The information processing device is not limited to the multi-function peripheral as long as the information processing device operates in accordance with the operation received from the operation panel.

In the second to the fourth embodiments, the operation panel 30 is not limited to a panel which forms a part of the information processing device 10 and which is attached to and detached from the main body 10A of the information processing device 10. For example, in the information processing device, the operation panel which cannot be detached from the information processing device is fixedly provided, and another operation panel which is different from the fixedly-provided operation panel and which can operate this information processing device, is used as the operation panel according to the present invention.

One of the objects of the above embodiments and the like is to provide an operation panel and an information processing device which can prevent the operation which is not suitable for the attachment state or the like of the operation panel, when the operation panel which is attachable to and is detachable from the main body is used.

In at least one of the embodiments and the like, when the operation panel is not attached to the predetermined device, the operation relating to the first function of the predetermined device can be carried out from the operation panel and the operation relating to the second function of the predetermined device cannot be carried out from the operating unit. Further, when the operation panel is attached to the predetermined device, at least the operation relating to the second function can be carried out from the operation panel. That is, the second function is prohibited from being operated from the operation panel when the operation panel is detached from the predetermined device.

In at least one of the embodiments and the like, when the operation panel is not attached to the predetermined device, the operation relating to the third function of the predetermined device can be carried out from the operation panel. Further, when the operation panel is attached to the predetermined device, the operation relating to the third function cannot be carried out from the operation panel. That is, the third function is prohibited from being operated from the operation panel when the operation panel is attached to the predetermined device.

In at least one of the embodiments and the like, when the operation panel is not within the predetermined range from the predetermined device, the operation relating to the first function of the predetermined device can be carried out from the operation panel and the operation relating to the second function of the predetermined device cannot be carried out from the operation panel. Further, when the operation panel is within the predetermined range from the predetermined device, at least the operation relating to the second function can be carried out from the operation panel. That is, the second function is prohibited from being operated from the operation panel when the operation panel is apart from the predetermined device outside of the predetermined range.

In at least one of the embodiments and the like, when the operation panel is not within the predetermined range from the predetermined device, the operation relating to the third function of the predetermined device can be carried out from the operation panel. Further, when the operation panel is within the predetermined range from the predetermined device, the operation relating to the third function cannot be carried out from the operation panel. That is, the third function is prohibited from being operated from the operation panel when the operation panel is near the predetermined device.

In at least one of the embodiments and the like, when the communication between the operation panel and the predetermined device by the first communication method is not established and the communication between the operation panel and the predetermined device by the second communication method is established, the operation relating to the first function of the predetermined device can be carried out from the operation panel and the operation relating to the second function of the predetermined device cannot be carried out from the operation panel. Further, when the communication between the operation panel and the predetermined device by the first communication method can be established, at least the operation relating to the second function can be carried out from the operation panel. That is, the second function is prohibited from being operated from the operation panel when the communication using the first communication method cannot be established.

In at least one of the embodiments and the like, when the communication between the operation panel and the predetermined device by the first communication method can be established, the operation relating to the third function cannot be carried out from the operation panel. Further, when the communication between the operation panel and the predetermined device by the first communication method cannot be established and the communication between the operation panel and the predetermined device by the second communication method is established, the operation relating to the third function of the predetermined device can be carried out from the operation panel. That is, the third function is prohibited from being operated from the operation panel when the communication using the first communication method can be established.

In at least one of the embodiments and the like, in the state that the operation panel is detached from the predetermined device or that the operation panel is not near the predetermined device, the operation for starting the print in the confidential job cannot be carried out from the operation panel.

In at least one of the embodiments and the like, in the state that the operation panel is attached to the predetermined device or that the operation panel is near the predetermined device, the operation relating to the web browsing function, which is carried out from the operation panel, is prohibited.

In at least one of the embodiments and the like, in the state that the operation panel is attached to the predetermined device or that the operation panel is near the predetermined device, the operation for accessing a website other than the specific website, which is carried out from the operation panel, is prohibited.

According to the operation panel and the information processing device, because the control unit switches the function which can be operated from the operation panel according to whether the operation panel is attached to the main body or the like, it is possible to prevent the user from carrying out the operation which is not suitable for the attachment state or the like of the operation panel, by using the operation panel.

What is claimed is:

1. An operation panel comprising:
an operating unit to receive an operation from a user;
a detecting unit to detect whether the operation panel is attached to a predetermined device;
a communication unit to be wirelessly communicable with the predetermined device; and
a control unit to switch a function of the predetermined device, which can be operated from the operating unit, so that the operation relating to a first function of the predetermined device can be carried out from the operating unit and the operation relating to a second function of the predetermined device cannot be carried out from the operating unit when the control unit recognizes that the operation panel is not attached to the predetermined device in accordance with a detection result of the detecting unit, and so that at least the operation relating to the second function can be carried out from the operating unit when the control unit recognizes that the operation panel is attached to the predetermined device in accordance with the detection result of the detecting unit.

2. The operation panel of claim 1, wherein the control unit switches the function of the predetermined device, which can be operated from the operating unit, so that the operation relating to a third function of the predetermined device can be carried out from the operating unit when the control unit recognizes that the operation panel is not attached to the predetermined device in accordance with the detection result of the detecting unit, and so that the operation relating to the third function cannot be carried out from the operating unit when the control unit recognizes that the operation panel is attached to the predetermined device in accordance with the detection result of the detecting unit.

3. An operation panel comprising:
an operating unit to receive an operation from a user;
a detecting unit to detect whether the operation panel is within a predetermined range from a predetermined device;
a communication unit to be wirelessly communicable with the predetermined device; and
a control unit to switch a function of the predetermined device, which can be operated from the operating unit, so that the operation relating to a first function of the predetermined device can be carried out from the operating unit and the operation relating to a second function of the predetermined device cannot be carried out from the operating unit when the control unit recognizes that the operation panel is not within the predetermined range from the predetermined device in accordance with a detection result of the detecting unit, and so that at least the operation relating to the second function can be carried out from the operating unit when the control unit recognizes that the operation panel is within the predetermined range from the predetermined device in accordance with the detection result of the detecting unit.

4. The operation panel of claim 3, wherein the control unit switches the function of the predetermined device, which can be operated from the operating unit, so that the operation relating to a third function of the predetermined device can be carried out from the operating unit when the control unit recognizes that the operation panel is not within the predetermined range from the predetermined device in accordance with the detection result of the detecting unit, and so that the operation relating to the third function cannot be carried out from the operating unit when the control unit recognizes that the operation panel is within the predetermined range from the predetermined device in accordance with the detection result of the detecting unit.

5. An operation panel comprising:
an operating unit to receive an operation from a user;
a first communication unit to communicate with a predetermined device by a first communication method;
a second communication unit to communicate with the predetermined device by a second communication method; and
a control unit to switch a function of the predetermined device, which can be operated from the operating unit, so that the operation relating to a first function of the predetermined device can be carried out from the operating unit and the operation relating to a second function of the predetermined device cannot be carried out from the operating unit when communication between the operation panel and the predetermined device via the first communication unit cannot be established and communication between the operation panel and the predetermined device via the second communication unit is established, and so that at least the operation relating to the second function can be carried out from the operating unit when the communication between the operation panel and the predetermined device via the first communication unit can be established.

6. The operation panel of claim 5, wherein the control unit switches the function of the predetermined device, which can be operated from the operating unit, so that the operation relating to a third function of the predetermined device can be carried out from the operating unit when the communication between the operation panel and the predetermined device via the first communication unit cannot be established and the communication between the operation panel and the predetermined device via the second communication unit is established, and so that the operation relating to the third function cannot be carried out from the operating unit when the communication between the operation panel and the predetermined device via the first communication unit can be established.

7. The operation panel of claim 1, wherein the second function is a function for carrying out an authorized instruction for starting a print in a confidential job in which execution of the print is suspended in the predetermined device until the authorized instruction for starting the print is received from the operation panel.

8. The operation panel of claim 3, wherein the second function is a function for carrying out an authorized instruction for starting a print in a confidential job in which execution of the print is suspended in the predetermined device until the authorized instruction for starting the print is received from the operation panel.

9. The operation panel of claim 5, wherein the second function is a function for carrying out an authorized instruction for starting a print in a confidential job in which execution of the print is suspended in the predetermined device until the authorized instruction for starting the print is received from the operation panel.

10. The operation panel of claim 2, wherein the third function is a web browsing function.

11. The operation panel of claim 4, wherein the third function is a web browsing function.

12. The operation panel of claim 6, wherein the third function is a web browsing function.

13. The operation panel of claim 2, wherein the third function is a function for accessing a website other than a specific website by using a web browser.

14. The operation panel of claim 4, wherein the third function is a function for accessing a website other than a specific website by using a web browser.

15. The operation panel of claim 6, wherein the third function is a function for accessing a website other than a specific website by using a web browser.

16. The operation panel of claim 5, wherein the first communication method is cable communication, and the second communication method is wireless communication.

17. The operation panel of claim 5, wherein the first communication method is short-distance wireless communication, and the second communication method is wireless communication other than the short-distance wireless communication.

18. An information processing device comprising:
a main body to execute a first function and a second function;
an operation panel to receive an operation from a user, the operation panel being attachable to and detachable from the main body;
a detecting unit to detect whether the operation panel is attached to the main body or not;
a communication unit to carry out wireless communication between the operation panel and the main body; and
a control unit to switch a function of the main body, which can be operated from the operation panel, so that the operation relating to the first function of the main body can be carried out from the operation panel and the operation relating to the second function of the main body cannot be carried out from the operation panel when the operation panel is not attached to the main body, and so that at least the operation relating to the second function can be carried out from the operation panel when the operation panel is attached to the main body.

19. The information processing device of claim 18, wherein the control unit switches the function of the main body, which can be operated from the operation panel, so that the operation relating to a third function of the main body can be carried out from the operation panel when the operation panel is not attached to the main body, and so that the operation relating to the third function cannot be carried out from the operation panel when the operation panel is attached to the main body.

20. An information processing device comprising:
a main body to execute a first function and a second function;
an operation panel to receive an operation from a user;
a detecting unit to detect whether the operation panel is within a predetermined range from the main body or not;
a communication unit to carry out wireless communication between the operation panel and the main body; and
a control unit to switch a function of the main body, which can be operated from the operation panel, so that the operation relating to the first function of the main body can be carried out from the operation panel and the operation relating to the second function of the main body cannot be carried out from the operation panel when the operation panel is not within the predetermined range from the main body, and so that at least the operation relating to the second function can be carried out from the operation panel when the operation panel is within the predetermined range from the main body.

21. The information processing device of claim 20, wherein the control unit switches the function of the main body, which can be operated from the operation panel, so that the operation relating to a third function of the main body can be carried out from the operation panel when the operation panel is not within the predetermined range from the main body, and so that the operation relating to the third function cannot be carried out from the operation panel when the operation panel is within the predetermined range from the main body.

22. An information processing device comprising:
a main body to execute a first function and a second function;
an operation panel to receive an operation from a user;
a detecting unit to detect whether the operation panel is within a predetermined range from the main body or not;
a communication unit to carry out communication between the operation panel and the main body by a first communication method and by a second communication method; and
a control unit to switch a function of the main body, which can be operated from the operation panel, so that the operation relating to the first function of the main body can be carried out from the operation panel and the operation relating to the second function of the main body cannot be carried out from the operation panel when the communication between the operation panel and the main body by the first communication method cannot be established and the communication between the operation panel and the main body by the second communication method is established, and so that at least the operation relating to the second function can be carried out from the operation panel when the communication between the operation panel and the main body by the first communication method can be established.

23. The information processing device of claim 22, wherein the control unit switches the function of the main body, which can be operated from the operation panel, so that the operation relating to a third function of the main body can be carried out from the operation panel when the communication between the operation panel and the main body by the first communication method cannot be established and the communication between the operation panel and the main body by the second communication method is established, and so that the operation relating to the third function cannot be carried out from the operation panel when the communication between the operation panel and the main body by the first communication method can be established.

24. The information processing device of claim 18, wherein the second function is a function for carrying out an authorized instruction for starting a print in a confidential job in which execution of the print is suspended in the main body until the authorized instruction for starting the print is received from the operation panel.

25. The information processing device of claim 20, wherein the second function is a function for carrying out an authorized instruction for starting a print in a confidential job in which execution of the print is suspended in the main body until the authorized instruction for starting the print is received from the operation panel.

26. The information processing device of claim 22, wherein the second function is a function for carrying out an authorized instruction for starting a print in a confidential job in which execution of the print is suspended in the main body until the authorized instruction for starting the print is received from the operation panel.

27. The information processing device of claim 19, wherein the third function is a web browsing function.

28. The information processing device of claim 21, wherein the third function is a web browsing function.

29. The information processing device of claim 23, wherein the third function is a web browsing function.

30. The information processing device of claim 19, wherein the third function is a function for accessing a website other than a specific website by using a web browser.

31. The information processing device of claim 21, wherein the third function is a function for accessing a website other than a specific website by using a web browser.

32. The information processing device of claim 23, wherein the third function is a function for accessing a website other than a specific website by using a web browser.

33. The information processing device of claim 22, wherein the first communication method is cable communication, and the second communication method is wireless communication.

34. The information processing device of claim 22, wherein the first communication method is short-distance wireless communication, and the second communication method is wireless communication other than the short-distance wireless communication.
